(19) United States
(12) Patent Application Publication
(10) Pub. No.: US 2023/0364939 A1
(43) Pub. Date: Nov. 16, 2023

(54) DECORATIVE COATING SYSTEM AND METHOD FOR DECROATIVE PRODUCTS

(71) Applicant: Carl Robinson, JR., Monroe, LA (US)

(72) Inventor: Carl Robinson, JR., Monroe, LA (US)

(21) Appl. No.: 18/025,547

(22) PCT Filed: Sep. 10, 2021
(86) PCT No.: PCT/US21/49865

§ 371 Date: Mar. 9, 2023

Related U.S. Application Data
(60) Provisional application No. 63/076,639, filed on Sep. 10, 2020.

(51) Int. Cl. B44F 9/08; A43B 3/00; B44F 1/08

(52) U.S. Cl. CPC B44F 9/08; A43B 3/0084; B44F 1/08

(57) ABSTRACT

An outer surface of a Decorative Product comprising an outer covering layer covering the outer surface, the outer covering layer comprises a UV ink coating layer and an outer protective layer disposed on a surface of the UV ink coating layer facing towards the exterior of the Decorative Product. The UV ink coating layer comprises a plurality of close-packed jewel-shaped elements and the surface of the UV ink coating layer comprises an elongated mesa-like protrusion having a substantially planar top face. The outer protective layer includes an amber varnish layer. The outer protective layer is configured to protect the appearance, color and brightness of the jewel-shaped element.

### CROSS REFERENCE TO RELATED DISCLOSURES

The present disclosure is a U.S. National Phase Entry of International Application No. PCT/US21/49865 filed on Sep. 10, 2021 and claims the benefit if U.S. Provisional Application No. 63/076,639 filed Sep. 10, 2020, the disclosure of which being incorporated herein in entirety.

### TECHNICAL FIELD

The present disclosure relates to a decorative coating and methods of making the same.

### BACKGROUND

Many different products are often decorated as a way of expressing one's personality, as well as drawing the attention of others. One technique for decorating products such as footwear, skates, skate boards, hoover boards, water skis, snow and ski boards, writing instruments (i.e. pencils and ink pens), automobiles, boats, ships, cruisers, off-road vehicles, motorcycles, bicycles, scooters, golf clubs, eyeglasses, furniture, clothing, headgear (i.e. caps, hats, and visors), computer cases and accessories (i.e. mouse, keyboard, and monitor), home appliances, kids toys, and the like (collectively “Decorated Products”) is to accent the Decorative Products with attractive colors and patterns.

### SUMMARY

The present disclosure relates to utilizing a semitransparent film to enhance the reflectance of multiple separate jewel-shaped objects or charms defined on the Decorative Products so that they are not dull in appearance or so they appear jewel-shaped (e.g., having high brilliance). The semitransparent film may be fixed to the surface of an Ultraviolet (“UV”) ink coating layer using an adhesive, such as epoxy or glue, or may be applied using a heat press. However, over a period of time the film material may not hold up to the usage (wear and tear) the Decorative Products demand. More specifically, UV rays effect the jewel-shaped appearance on the thin semitransparent film and over a period of time the colors, brilliancy, and the imagery of the diamond pattern may fade and deteriorate, thus decreasing the quality in the appearance of the diamond overspread pattern. Such deterioration does not display the appearance, characteristic of a diamond/jewel with the intended brilliance. Furthermore, other than the appearance of the diamond design, a Decorative Product with a diamond design compared to a Decorative Product without a diamond design carries more importance. A diamond finish on a Decorative Product is held in high esteem. Any portion of the design that is obstructed degrades the message and the quality in its appearance for the Decorative Products and therefore devalues the Decorative Products as a whole. Accordingly, this disclosure provides a system and method for minimizing such degradation of the diamond finish on the Decorative Products among other things.

The present disclosure relates to applying a diamond finish on Decorative Products, and methods for making the same, in which the diamond pattern is printed directly onto capable Decorative Products materials such as leather, polyester, clothe, plastic, metal, wood, fiberglass composites, etc. (generally referred to as “Material”), a raised effect of the diamond pattern is created by using a printing technique called Raised UV Coatings or Raised UV printing (also referred to as 3D UV or Sculpted UV printing). After the image is printed onto the Material or in a two or three dimensional composition then the diamond pattern is applied with the improvement application, i.e., an Amber Varnish Solution. The Amber Varnish Solution improvement benefit is that when applied to the diamond pattern it provides a protective coating that preserves the diamond pattern's appearance. The UV Printing extract an ink that builds by layers the Diamond Pattern onto the Material for the Decorative Products. The ink may be unable to withstand the abrasive activity of the Decorative Product, especially a 3D composition, because it may cause the ink to gradually peel, nick away and ultimately dismantle the Diamond Pattern without the protective coating. However, an Amber Varnish application protects and stabilize the ink for years against the abrasive activity, cracking, fading, and deterioration; therefore, an Amber Varnish application is beneficial in the protection of the diamond pattern.

It should be noted that the Decorative Products discussed herein are not intended as exclusive examples. Rather, any object that has a surface that can receive the materials discussed herein is considered as well. For the conciseness, Decorative Products will be taken as an example in the Detailed Description for describing the present invention, and the present invention should be construed as not limited to the specific Decorative Products discussed but, on the contrary, as applicable to all kinds of products.

In general, the subject matter of the present disclosure can be embodied in Decorative Products, in which the outer covering layer has, a UV ink coating layer disposed on at least a portion of the surface facing towards the exterior of the Decorative Product, wherein the UV ink coating layer includes a plurality of close-packed jewel-shaped elements, and the surface of the UV ink coating layer comprises an elongated mesa-like protrusion having a substantially planar top face, and an outer protective layer disposed on the surface of the UV ink coating layer facing away from the interior. Wherein the outer protective layer includes an amber varnish layer, for protecting the jewel-shaped elements so as to keep the appearance, color and brilliance thereof.

In the present disclosure, the term “UV ink coating layer” refers to such structure in form of layer created by using such a printing technique called Raised UV Coatings or Raised UV printing, which is also referred to as 3D UV or Sculpted UV printing.

The Decorative Product can include one or more of the following features.

For example, in some implementations, the jewel-shaped elements are rhomboids or diamonds.

In some implementations, the jewel-shaped elements are raised or planar jewel-shaped elements.

In some implementations, each jewel-shaped element in the close-packed jewel-shaped elements comprises a plurality of facets, each facet being raised at an oblique angle from at least one other facet in the jewel-shaped element.

In some implementations, each jewel-shaped element has a short axis and a plurality of boundaries extending along directions normal to the short axis, the plurality of boundaries enclosing one or more facets on a face of the jewel-shaped element

In some implementations, the boundaries of each jewel-shaped element are grooves.

In some implementations, an outer surface of the outer covering layer is planar across the jewel-shaped elements and the entire outer surface of the outer covering layer faces away from an interior region of the Decorative Product.

In some implementations, a clear, self-adhesive vinyl is applied across the jewel-shaped elements.

In some implementations, the jewel-shaped elements are of at least one color so as to exhibit a tint of different colors.

In some implementations, the Decorative Product further comprises a fabric affixed to an interior lining and attached to an outer covering layer and forming a portion of an exterior of the Decorative Product, wherein the fabric is selected from the group consisting of natural leather, artificial leather, composite leather, cotton, polyester, rubber, fake or natural fur, artificial or natural animal skins, metal, plastic, wood, fiberglass, composites, and combinations thereof.

In some implementations, the Decorative Product further comprises one or more light emitting devices, a switch and a power source, wherein the one or more light emitting devices are coupled to the switch and the power source through one or more wires and are embedded in one or more housings, and wherein the interior lining forms sidewalls to the housings, and the outer covering layer forms a cover of the one or more housings.

In a further implementation, the upper further comprises a polyurethane layer over the amber varnish layer. The polyurethane layer is used as a shine enhancement. Polyurethane comes in three type of sheen performance: High Gloss, Semi-Gloss, and Satin. A high gloss polyurethane is layered over the amber varnish and dries to a very shiny surface. The polyurethane shine provides an enhancement to the already brightness in colors and jewel-shaped elements created by the amber varnish application. The polyurethane provides the jewel-shaped elements with an added brilliance, shine effects that typify the likeness of a real, exceptional brilliant diamond; whereas to attract, appeal to the senses of the wearer or user of the diamond designed Decorative Product and sparks the attention of onlookers.

In some implementations, the UV ink coating layer covers the entire surface of the exterior of the Decorative Product.

In some implementations, the Decorative Product comprises a boot, a dress shoe, a sandal, a flat, a running shoe, an athletic shoe, a skate, an ice skate, a roller skate or roller blades, a snow skate, a snow ski boot, a water ski boot, skate boards, hoover boards, water skis, snow and ski boards, writing instruments (i.e. pencils and ink pens), automobiles, boats, ships, cruisers, off-road vehicles, motorcycles, bicycles, scooters, golf clubs, eyeglasses, furniture, clothing, headgear (i.e. caps, hats, and visors), computer cases and accessories (i.e. mouse, keyboard, and monitor), home appliances, kids toys, and the like or the like.

In some implementations, each of the close-packed jewel-shaped elements is equal in size.

In some implementations, the interior lining comprises leather layer, polyester layer and/or cotton layer.

In some implementations, two or more raised or planar jewel-shaped elements of close-packed jewel-shaped elements can be of different colors. At least one of the jewel-shaped elements exhibits a tint of multiple different colors.

In some implementations, one or more of jewel-shaped elements have at least two boundaries of differing lengths.

In some implementations, each boundary of each jewel-shaped element is greater than about ¼ mm and less than about 76 mm. In other embodiments each boundary if each jewel-shaped element is greater than about 1 foot and less than about 1 yard.

In some implementations, the surface area of the elongated mesa-like protrusion is in the range of 144 mm² to 7000 mm². In other embodiments, the surface area is about 1 square inch to one square yard.

In some implementations, the elongated mesa-like protrusion can have a length between about 1 to 12 inches or 1 ft. to 400 yards, a width between about 0.5 to 3 inches or 1 foot to 300 yards, and a protrusion thickness between about 0.1 to 0.5 inches or 1 inch to one yard.

In some implementations, the face of each raised jewel-shaped element is smooth.

In some implementations, the face of each planar jewel-shaped element is smooth.

The details of one or more implementations are set forth in the accompanying drawings and the description below. Other aspects, features, and advantages will be apparent from the description and drawings, and from the claims.

### BRIEF DESCRIPTION OF DRAWINGS

FIG. 1 is a schematic illustrating an example of a Decorative Product according to the present disclosure.

FIG. 2 is a top view of planar jewel-shaped elements formed on a UV ink coating layer.

FIG. 3 is a schematic illustrating a side view of a UV ink coating layer (with planar jewel-shaped element) on which an Amber Varnish Solution is formed.

FIGS. 4A-4C are schematics depicting various views of raised facets of a UV ink coating layer (with raised jewel-shaped element).

FIG. 5 is a schematic illustrating a side-view of a decorative outer layer beneath which a light emitting source is positioned.

FIG. 6A is a schematic illustrating an example of a Decorative Product in which light sources are affixed to the upper part.

FIG. 6B is a schematic illustrating the example Decorative Product after a UV ink coating layer is applied to the Decorative Product.

FIG. 6C is a schematic illustrating an example of a Decorative Product separated into the upper and lower parts, in which light sources are affixed to the upper part.

FIGS. 6D-6E are schematics illustrating examples of a sneaker.

FIGS. 7A-7B are schematics illustrating examples of Decorative Product having protrusions formed in an UV ink coating layer formed on the outer surface of the interior lining.

FIGS. 8A-8I are schematic illustrations of this disclosure.

FIGS. 9A-9C are non-exclusive examples of Decorative Products.

### DETAILED DESCRIPTION

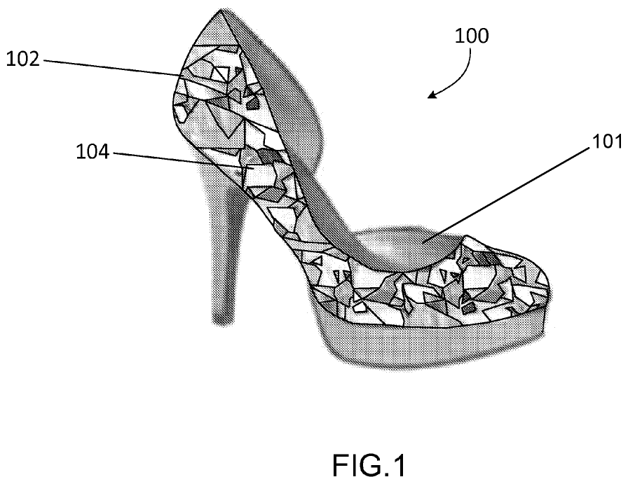

FIG. 1 is a schematic illustrating a perspective view of a decorative shoe 100 as a non-exclusive example of a Decorative Product according to the present disclosure. The decorative shoe 100 includes a sole and an upper attached to the sole. The upper has an interior lining 101 and an outer covering layer covering the interior lining 101. The outer covering layer comprises a UV ink coating layer 102 and an outer protective layer 300 disposed on a surface of the UV ink coating layer 102 facing away from the interior lining 101. The outer protective layer 300 includes an amber varnish layer.

According to the implementations of the present disclosure, the UV ink coating layer 102 is such structure in form of layer created by using such a printing technique called Raised UV Coatings or Raised UV printing, which is also referred to as 3D UV or Sculpted UV printing. The UV ink coating layer 102 includes an array of decorative jewel-shaped elements 104. That is, each element 104 is configured to simulate the appearance of a jewel or gemstone such as a rhomboid, diamond, ruby, sapphire, emerald, garnet, topaz, among others. For example, each element 104 may include multiple grooves defining the element's boundary, and have relatively high brilliance/reflectance.

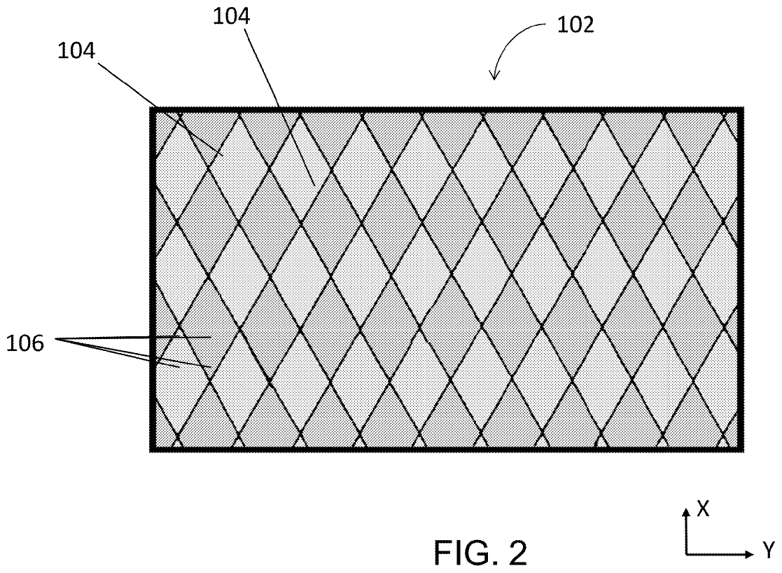

FIG. 2 is a schematic illustrating a two-dimensional view of a portion of UV ink coating layer 102 containing the jewel-shaped elements 104. A jewel-shaped element 104 is configured to have a polygon shape with a short axis equal to the thickness of the UV ink coating layer 102 (i.e., into the page for the example shown in FIG. 2) and an upper face enclosed by three or more boundaries 106 extending along directions that are normal to the short axis. Each boundary of a jewel-shaped element forms an oblique angle with an adjacent boundary of the jewel-shaped element and follows the curvature of the UV ink coating layer 102 as defined by the shoe shape. The region enclosed by the boundaries 106 of each jewel-shaped element includes one or more facets.

In the example shown in FIG. 2, the jewel-shaped elements 104 each include 4 boundaries 106. In some implementations, the elements 104 are configured to appear like diamonds or rhombuses, e.g., a quadrilateral having sides of approximately equal length, and in which the diagonals are substantially perpendicular and bisect each other. Alternatively, and in contrast to the pattern shown in FIG. 2, the sides of the elements 104 can have different lengths. Furthermore, the elements 104 are close-packed such that there is little or no distance between adjacent elements 104. Though the diamond-shaped elements 104 of FIG. 2 appear in a repeating pattern, in some cases the elements 104 may be arranged such that there is no recognizable repeating pattern, e.g., the elements 104 have different sizes and are arranged in a non-repeating pattern (e.g., randomly), and/or in a different diamond pattern or a various diamond pattern. The area of the jewel shape elements 104 has a length in the range of 1 inch to 400 yards and a width of 1 inch to 300 yards. The height of the jewel shape element 104, as measured from the interior lining can range from about 0.5 mm to 1 yard. Each boundary 106 of a polygon shaped element 104 has a length in the range of about ¼ mm to about 76 mm and/or 1 foot to 3 yards. For example, the length can be about 1 mm, 5 mm, 10 mm, 20 mm, 30 mm, 40 mm, 50 mm, or 60 mm. Optionally, the boundaries 106 of each element 104 correspond to thin grooves or channels extending within the surface of the UV ink coating layer 102, such that the jewel-shaped elements 104 are effectively raised features on the UV ink coating layer surface. For example, the grooves may be formed in the layer 102 as a result of a UV coating process. The thickness of the grooves is shallow relative to the thickness of the UV ink coating layer 102. For example, the grooves 10 can have a depth in the range of about 0.5 mm to about 0.9 mm, such as 0.76 mm and/or 1 inch to 1 foot, whereas the UV ink coating layer has a thickness that is greater than the groove depth. The range of thicknesses for the UV ink coating layer 102 can be between about 1 mm to about 30 mm, such as 3.5 mm and or 1 inch to 12 inches.

The UV ink coating layer 102 is formed from a material suitable to Raised UV Coating or Raised UV printing processes (also referred to as 3D UV or Sculpted UV). However, in some implementations, the material is also tinted to exhibit a particular color. For example, the layer 102 may be tinted red, blue, green, purple, among other colors. In an example, the UV ink coating layer 102 can be fixed to an interior lining of the Decorative Product.

In some implementations, two or more raised or planar jewel-shaped elements 104 of close-packed jewel-shaped elements 104 can be of different colors. At least one of the jewel-shaped elements exhibits a tint of multiple different colors.

With such configuration, in one implementation, all of the jewel-shaped elements are of same one color, such as green, red, blue, yellow or purple, over the entire surface of the UV ink coating layer, such that the jewel-shaped elements, as a whole, can exhibit the single one color, which is different from another shoe including jewel-shaped elements of single one different color. In a further implementation, the jewel-shaped elements are not of the same one color and, instead, of multiple different colors over the entire surface of the UV ink coating layer. That is, for example, some of the elements are of red color, some blue, some green, and so on. As such, the jewel-shaped elements exhibit a tint of multiple different colors.

The interior lining can include any suitable lining for a Decorative Product such as natural leather, artificial leather, composite leather, cotton, polyester, metal, plastic, wood, fiberglass, and composites among others.

In some implementations, the outer surface of the UV ink coating layer 102 is smooth. That is, the area within each of the elements 104 is planar with little variation in height (e.g., less than about 0.05 mm in average roughness, less than about 0.01 mm in roughness, less than about 0.001 mm in roughness, or as available with commercially obtained PMMA), though the UV ink coating layer 102 may be associated with some curvature to allow for conforming to the shape of the Decorative Product.

In some implementations, the outer surface of the outer covering layer is planar across the jewel-shaped elements and the entire outer surface of the outer covering layer faces away from an interior region of the Decorative Product. In some further implementations, a clear, self-adhesive vinyl is applied across the planar or raised closed-packed jewel-shaped elements.

Various techniques can be used to make the elements 104 not dull in appearance or so they appear jewel-shaped (e.g., having high brilliance). For example, the raised effect of the diamond pattern is created by printing techniques of Raised UV coating or Raised UV printing (also known as 3D UV or Sculpted UV), and an amber varnish layer is formed on the elements 104 of the UV ink coating layer 102 to make the elements 104 not dim in appearance and to protect from the dismantle of the elements 104. Compared with general printing, Raised UV coating or Raised UV printing has many advantages, such as, having a simple process; the pattern can be customized and widely compatible (can be applied to hundreds of materials such as glass, tile, or acrylic, leather etc.); the products produced are very rich in light and artistic effects; the surface is raised and flexible. That is, the jewel-shaped raised elements produced by Raised UV coating or Raised UV printing technique process is less time-consuming and UV ink materials are less expensive than other techniques and materials to form the Jewel-shaped elements such as an injection molding, compression molding technique with the use of plastic or lucite materials; furthermore, the jewel-shaped raised elements made from UV coating or raised UV printing have smooth surface effects, good texture, high brightness, high smoothness, strong adhesion, safe packaging, and folding resistance. In addition, the amber varnish protective layer formed on the jewel-shaped element can prevent the color, brightness, and image of the diamond pattern from abrasive activity, cracking, fading and deterioration. The combination of the UV ink coating layer created by the raised UV coating or raised UV printing and the amber varnish layer form thereon achieves a nonexclusive purpose of the disclosure: to keep the color, brightness and appearance of the diamond pattern on the Decorative Product in good condition, and to avoid the color, brightness and image of the diamond pattern from abrasive activity, cracking, fading and deterioration.

In some applications, Polyurethane is used as a shine enhancement. Polyurethane comes in three type of sheen performance: High Gloss, Semi-Gloss, and Satin. In some applications, a high gloss polyurethane is layered over the amber varnish and dries to a very shiny surface. The polyurethane shine provides an enhancement to the already brightness in colors and jewel-shaped elements created by the amber varnish application. The polyurethane provides the jewel-shaped elements with an added brilliance shine effects that typify the likeness of a real, exceptional brilliant diamond; whereas to attract, appeal to the senses of the wearer of the diamond designed shoe and sparks the attention of onlookers.

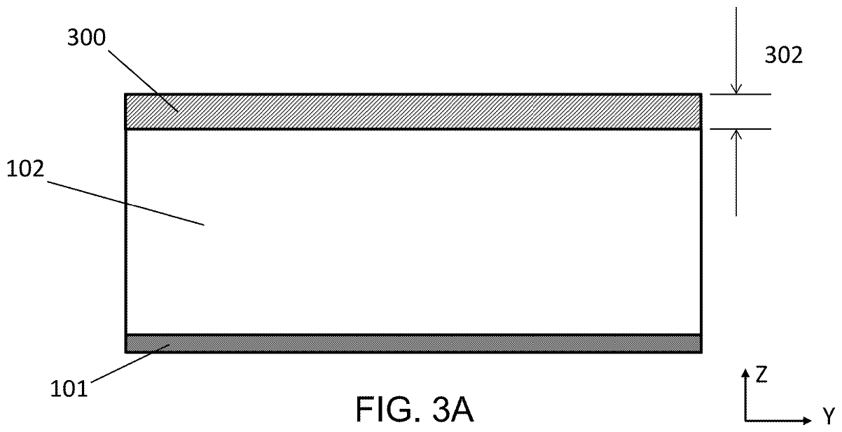

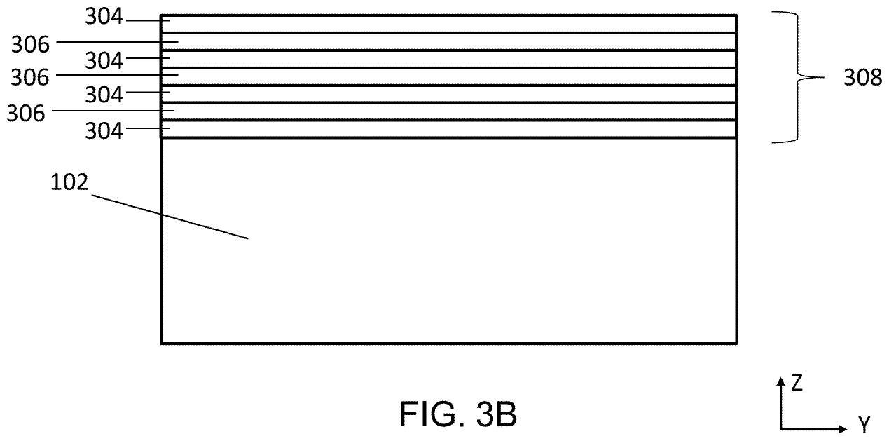

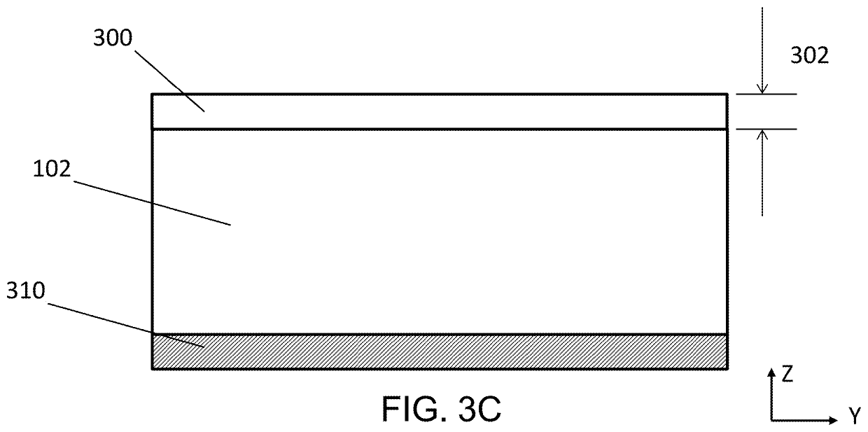

FIG. 3 is a side view of an example of an UV ink coating layer 102 (with planar jewel-shaped element) on which an outer protective layer 300 is formed. In some implementation, the outer protective layer 300 is an amber varnish layer. The UV ink coating layer 102 is affixed to an interior lining 101 of the Decorative Product. The method of affixing the outer protective layer 300 and the UV ink coating layer 102 to the interior lining 101 is as follows: printing the diamond pattern directly on the applicable Decorative Product material, for example plastic, metal, wood, fiberglass, rubber, leather, polyester, etc.

Specifically, the printing of the diamond pattern is applied to the material in a two-dimensional composition. The two-dimensional composition uses the computer to execute applicable graphic design software (such as computer-aided design (CAD)) to create the planar surface of the diamond pattern. A CAD system is utilized to generate diamond patterns for print.

In a three-dimensional composition, a raised effect of the diamond pattern is created by using a printing technique called Raised UV coating or Raised UV printing. Raised UV printing is a spot UV technique that builds up the UV coating to create three-dimension images you can both see and feel and thus create a UV ink coating layer. Raised UV coating/printing is completely different from other forms of tactile finishes such as embossing which presses a design into the material such as paper, and thermography which has raised ink. Raised UV coating/printing allows the clear UV coating to be completely independent of ink or pressing a design through both sides of a piece. Some uses of Raised UV coating/printing enhance the graphics or photography of an article. Examples include a football where you can feel the grain of the hide, an iguana where you can feel every scale, droplets of “water” on a beer bottle, or the feel of an orange peel.

In one example, the Raised UV printing comprises the following specific steps:
1. Applying UV-curable inkjet ink on the material. The ink can be configured in multiple colors, such as white, black, and color, and optionally, can be applied in various patterns, such as the diamond pattern; and
2. UV curing.

After the diamond pattern is printed on a material of the Decorative Products in a two-dimensional composition or the raised diamond pattern is printed on another suitable Decorative Product material in a three-dimensional composition, an amber varnish solution is applied on the diamond pattern (e.g., raised or planar jewel-shaped element).

The improved benefit of the amber varnish solution is to protect the ink against abrasive activity, cracking, fading, and deterioration. Also, the amber varnish brightens and gives depth as it penetrates and becomes part of the ink coating layer that makes up the diamond pattern and the structure on which the diamond pattern is applied as it is absorbed into the material.

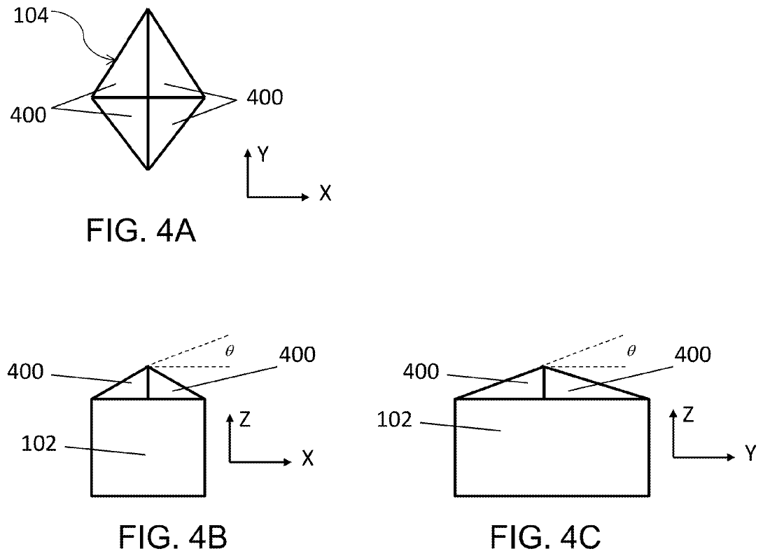

In other implementations, each element 104 of UV ink coating layer 102 (with raised jewel-shaped element) includes one or more facets raised at different oblique angles from one another to give the surface of the UV ink coating layer 102 a raised appearance. Each facet is a planar portion of the exposed surface of the UV ink coating layer and is oriented at a different angle from adjacent facets within a particular element 104. By orienting the facets at different angles, light reflected off the facets will be redirected in different directions enhancing the reflectance of the jewel-shaped elements 104. FIG. 4 is a schematic illustrating a top (FIG. 4A) and two side-views (FIGS. 4B, 4C) of an element 104 including multiple facets 400. In the example of FIG. 4, the element 104 includes 4 facets creating a square pyramid-like shape. The facets 400 are arranged at different angles with respect to a plane that is parallel to the x-axis and the y-axis, such that each facet is at an oblique angle with respect to at least one other facet. It should be noted that facets are shown with respect to the x-y plane for ease of viewing. In an implemented device, the UV ink coating layer would be curved to follow the curvature of the portion of the Decorative Product. Though the element 104 shown in FIG. 4 is divided into 4 separate facets, the element 104 may be composed of different numbers of facets including, for example, 1 facet, 2 facets, 6 facets, or 8 facets among others. The facets may be formed using Raised UV Coatings or Raised UV printing, (also referred to as 3D UV or Sculpted UV). The fabrication of the facets on the surface of the UV ink coating layer can result in the formation of grooves, as explained above, that separate the elements 104 from one another.

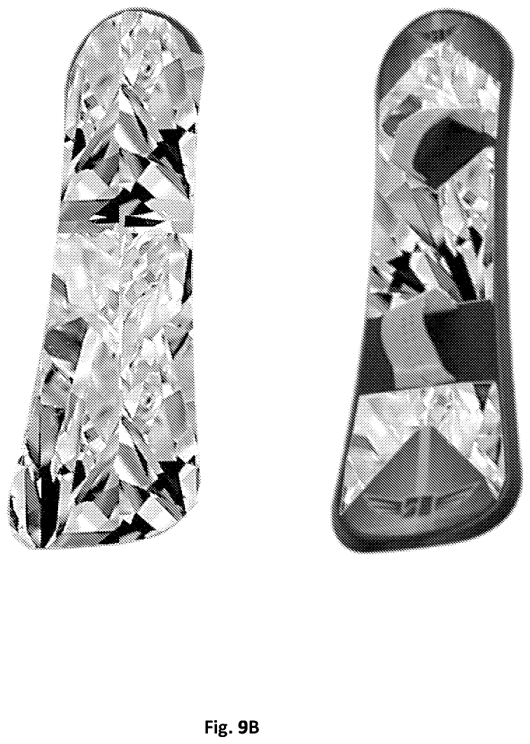

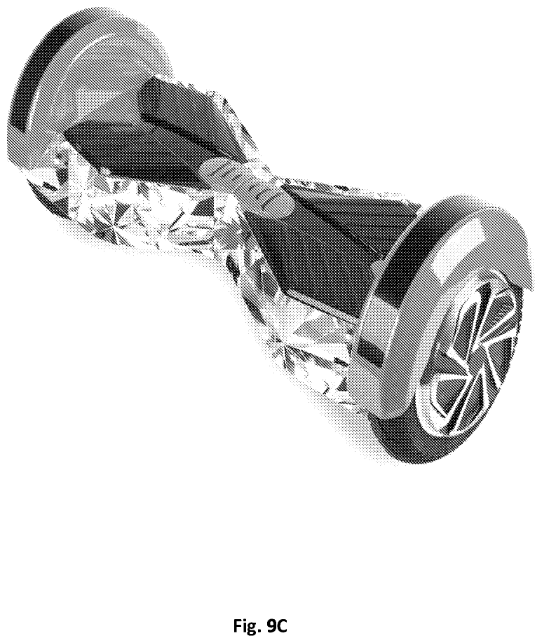

The UV ink coating layer 102 having the jewel-shaped elements 104 can be applied to any type of Decorative Product, including but not limited to: footwear, skates, skate boards, hoover boards, water skis, snow and ski boards, writing instruments (i.e. pencils and ink pens), automobiles, boats, ships, cruisers, off-road vehicles, motorcycles, bicycles, scooters, golf clubs, eyeglasses, furniture, clothing, headgear (i.e. caps, hats, and visors), computer cases and accessories (i.e. mouse, keyboard, and monitor), home appliances, kids toys, and the like among others (see FIGS. 9A-9C for several non-exclusive examples of Decorative Products). In some implementations, the UV ink coating layer 102 forms the entire outer surface of the Decorative Product, i.e., the surface that faces away from an inner element of the Decorative Product. In other implementations, the UV ink coating layer 102 forms only a portion of the Decorative Product as the outer surface of the Decorative Product. The remaining exterior portions of the Decorative Product that are not formed from layer 102 can include standard materials used to form Decorative Products, such as natural leather, artificial leather, composite leather, woven fabrics (e.g., cotton), polyester, rubber, fake fur, metal, plastic, wood, fiberglass, and composites, among other materials.

In some implementations, a light source is incorporated into the Decorative Product to enhance the brilliance of the jewel-shaped elements of the outer layer. For example, the Decorative Product can include one or more light sources, such as light-emitting diodes (LEDs), situated at various locations on the Decorative Product and beneath the outer layer 102. When the light sources are activated, light is emitted and passes through the transparent or translucent outer layer 102. The light sources may be configured to emit a single color/wavelength (e.g., red, blue, or green) or a range of wavelengths (e.g., white light). Combinations of white light and/or different color light sources may also be used. In some implementations, e.g., when the jewel-shaped elements 104 include raised facets, the light emitted from a single light source is refracted by the different facets along different directions, giving rise to an impression of multiple light sources being embedded at a particular location in the Decorative Product.

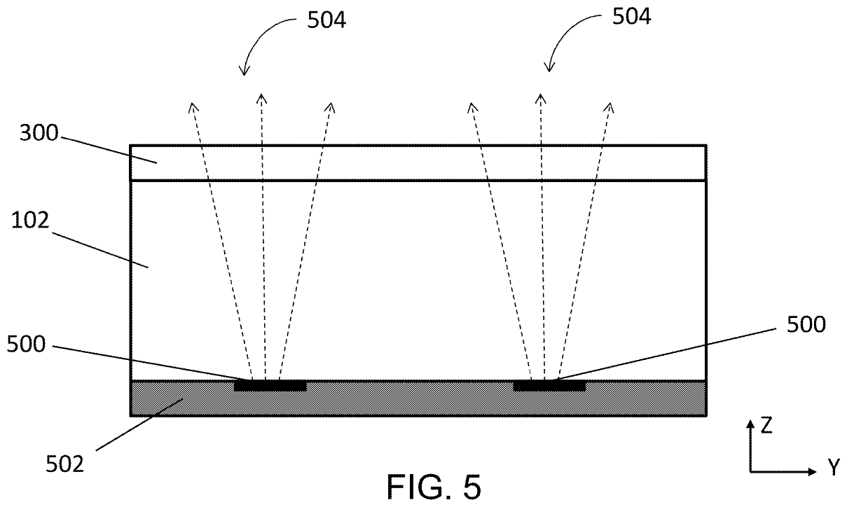

FIG. 5 is a side-view of an outer layer 102 beneath which a light emitting source 500 (e.g., a LED) is positioned. The light source 500 is arranged on or embedded in a base 502 (e.g., a padding layer such as the interior lining). When the light source 500 is embedded in the base 502 (e.g., embedded in a cavity or depression in the base 502), the outer layer 102 forms a cover over the light source 500, such that the outer layer 102 and the base 502 form a housing for the light source. The top surface of the light source facing the outer layer 102 emits light 504, such that the light 504 travels through the transparent or translucent outer layer 102. The outer layer 102 may also include a protection layer 300 on its surface.

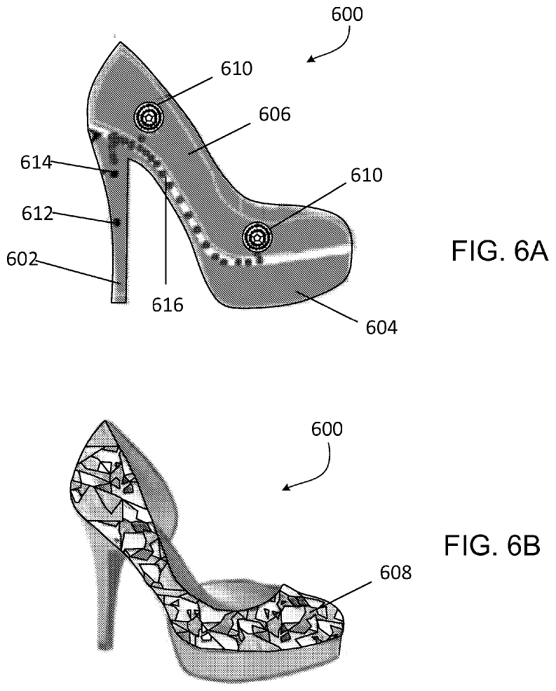

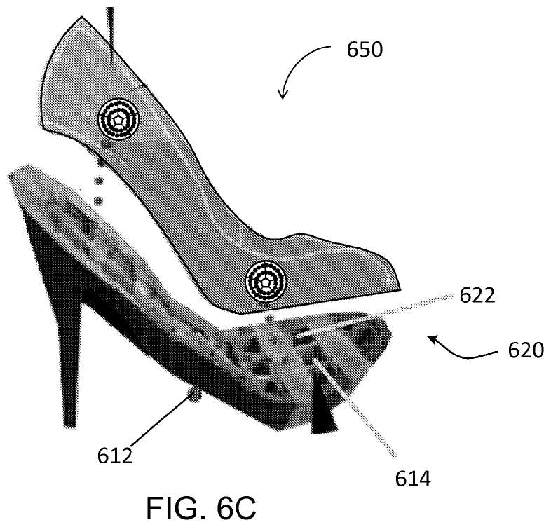

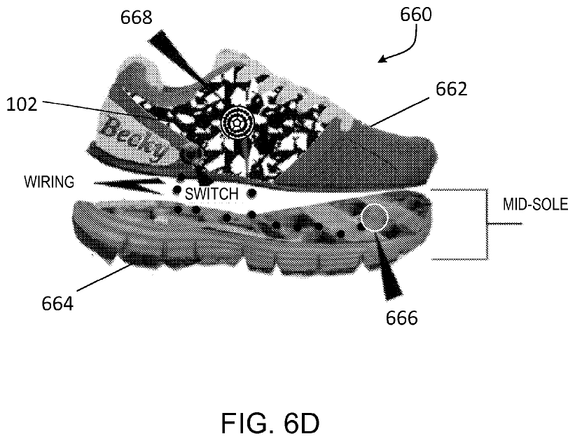

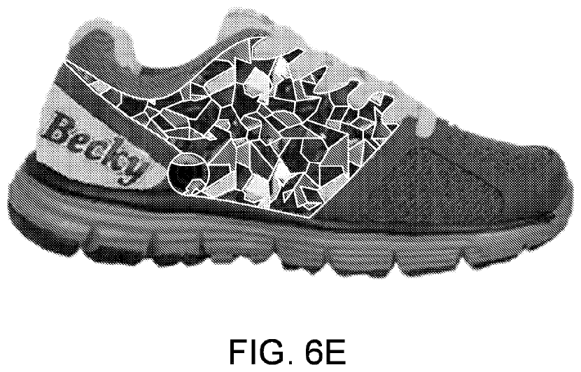

The light source may be located at various different positions of the Decorative Product. For example, FIG. 6A is a schematic illustrating an example of a shoe 600 that includes a heel 602, a platform 604 and an upper 606 without an outer layer. FIG. 6B is a schematic illustrating the shoe 600 with the outer layer 608 in place on the upper 606. As shown in FIG. 6A, two light sources 610 are arranged on the upper 606 so that when the outer layer 608 is formed on the upper, the outer layer 608 hides the light sources 610 from direct view. The light sources 610 are coupled to a switch 612 and power source 614 (e.g., a battery) through one or more wires 616. Both the wires 616 and power source 614 are hidden from view within the shoe 600. For example, the power source wires 616 may be threaded through the region between the platform 604 and the upper 606. The power source 614 may be arranged inside an opening in the heel 602. When activated, the switch 612 allows the light sources 610 to be activated with power from the power source 614. The switch 612 can include switches that are configured to be activated by hand. For example, the switch 612 may include a toggle that one can depress or move to different positions to change between a closed and open state for the circuit formed by the power source 614 and the light source 610. The switch 612 also may be positioned on the heel 602. The switch can be configured to blend into the surface of the heel 602 (e.g., by having the same color as the heel itself) so as not to draw attention to the switch 612.

Other configurations of the power source 614 and switch 612 also are possible. For example, in some implementations, the power source 614 can be embedded within the platform 604. FIG. 6C is a schematic illustrating an example of a shoe 650 separated into the upper and lower parts, in which the power source 614 is embedded in a mid-sole 620. The mid-sole 620 includes one or more openings 622 configured and sized to receive the power source 614. The portions of the mid-sole 620 surrounding the openings for the power source may be formed to have hard plastic walls to provide protection of the power source 614 and for stability. In the implementation shown in FIG. 6C, the switch 612 may be placed on the bottom of the shoe sole out of view when a user walks with the shoe 650 on.

Other shoe types also may be incorporate an outer layer, such as layer 102, and one or more light sources located beneath the outer layer. For example, FIGS. 6D and 6E are schematics illustrating a sneaker 660 as an example of the Decorative Product according to the present disclosure. The UV ink coating layer 102 is formed on the Decorative Product, i.e., sneaker 660. FIG. 6D shows the upper 662 of the sneaker 660 separated from the sole 664, in which a power source (e.g., battery) 666 is embedded. The power source is electrically coupled to one or more light sources 668 positioned beneath an outer layer 102 using wiring 661. A switch (e.g., a push-button, labeled “switch”) may be positioned on the outer layer 102, allowing a user to turn the light source(s) 668 on and off by depressing the switch. FIG. 6E illustrates the upper joined to the sole 664.

The teachings discussed herein are can be applied to any type of Decorative Product. While different shoe types are specifically illustrated and discussed herein, any type of Decorative Product may be configured to have an embedded power source, lights, and switches as discussed herein. The particular configuration for those components may vary per type of Decorative Product but the teachings discussed herein are equally applicable to provide for illuminating the outer surface.

In some implementations, the UV ink coating layer having the jewel-shaped elements also can include a protrusion on which the Decorative Product can be customized by the user. For example, the protrusion provides a region on which a user can apply their own signature (e.g., using any suitable writing instrument such as a permanent marker) or any desired pattern.

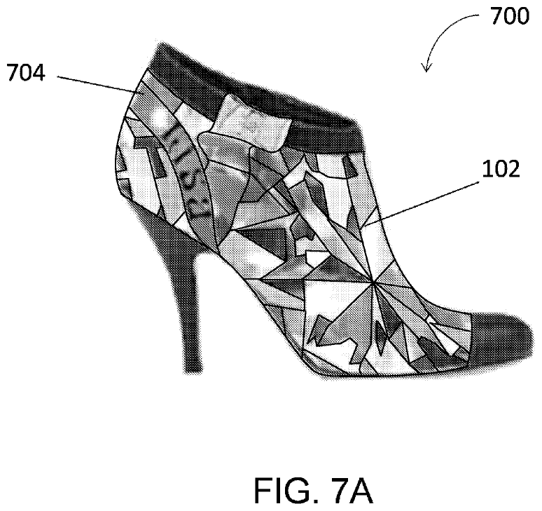

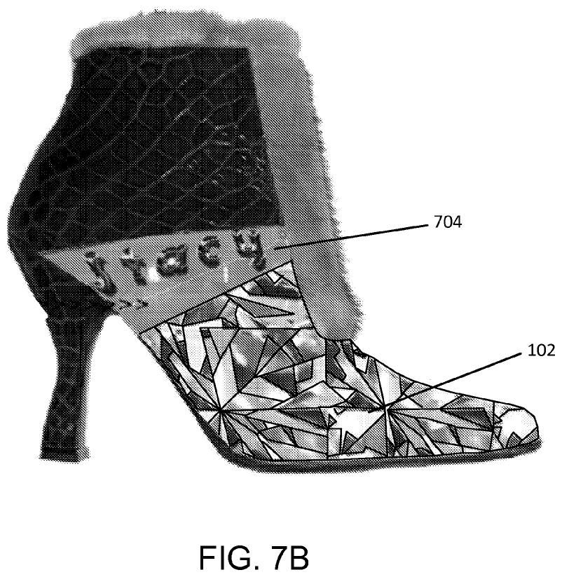

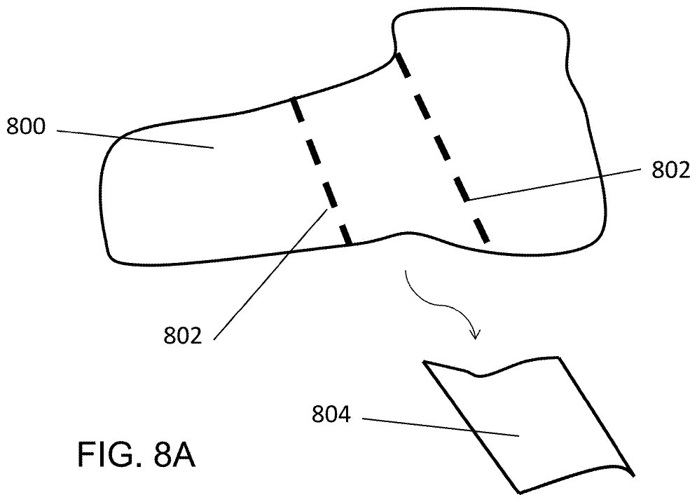

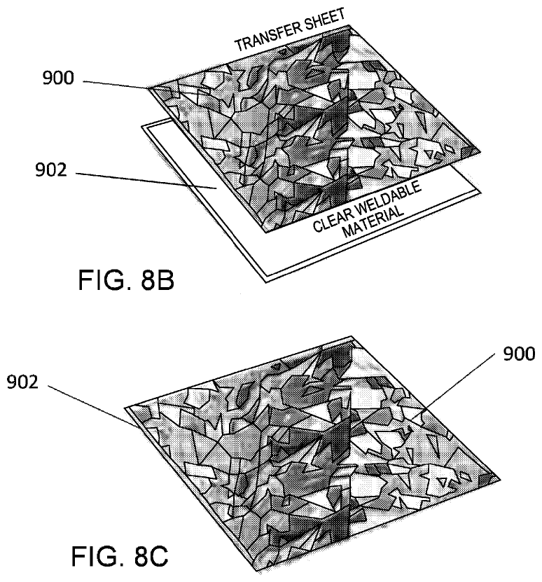

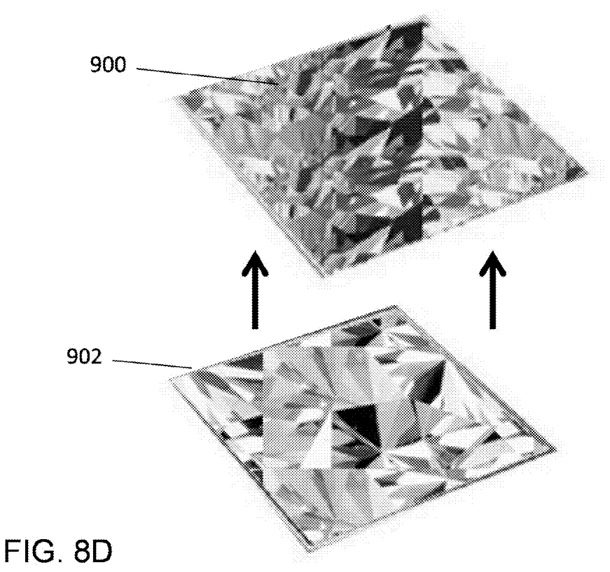

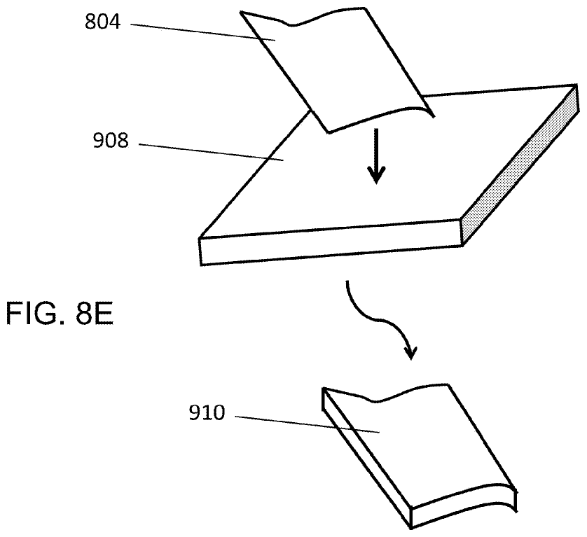

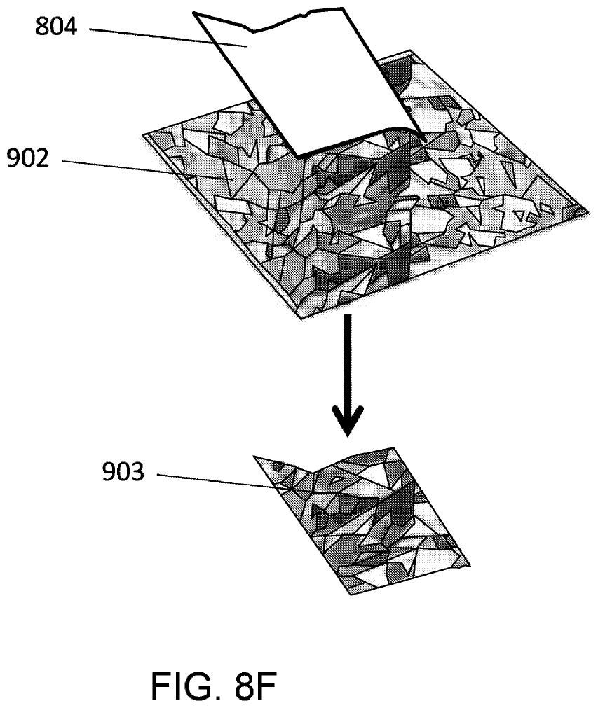

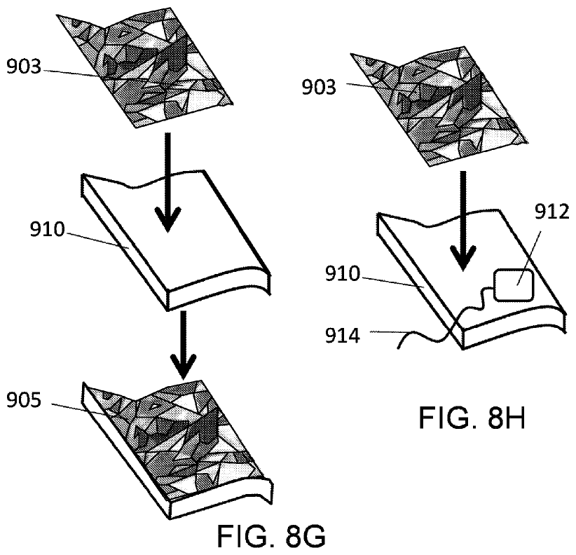

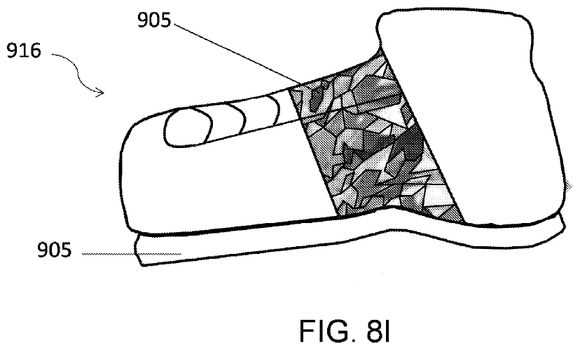

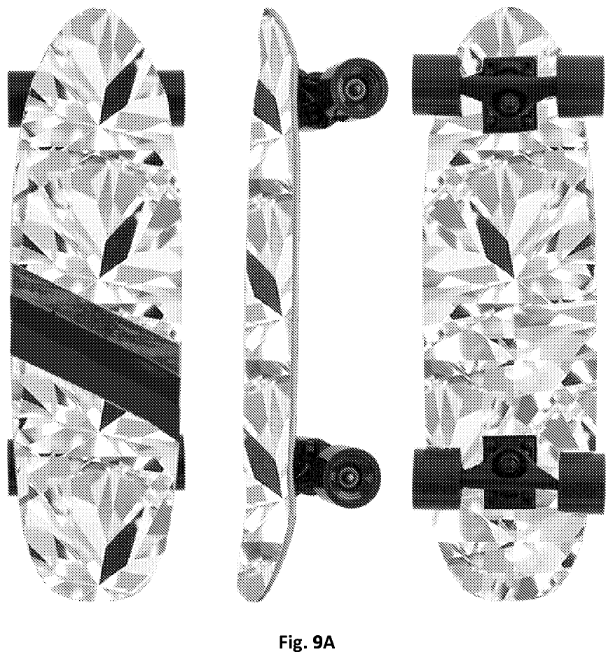

FIG. 7A is a schematic illustrating an example of a shoe 700 having a protrusion 704 formed in an UV ink coating layer 102. The UV ink coating layer 102 also contains an area having jewel-shaped elements as described above. The protrusion 704 is an elongated mesa-like shape having a substantially planar top face. Though substantially planar, the protrusion 704 may have some curvature to conform to the shape of the shoe. As a protrusion, the height of the area protrusion extends beyond the average height of other areas of the UV ink coating layer, e.g., the areas containing the jewel-shaped elements. The protrusion 704 is contiguously formed with the material constituting the UV ink coating layer 102 and is not a separate piece attached to the UV ink coating layer 102. Although in some cases for a particular style of shoe (e.g., athletic shoe, boot, heel, dress, skates, etc.), a separate protrusion piece may be applied to the UV ink coating layer 102 using an adhesive compound. In some implementations, the protrusion 704 can be differentiated from the other portions of the UV ink coating layer 102 by tinting the protrusion 704 a different color. For example, the protrusion 704 can be tinted red, whereas the remaining areas of the UV ink coating layer 102 can be tinted blue. The protrusion 704 can be formed using the same process (Raised UV printing,) used to establish the different jewel-shaped elements of the UV ink coating layer 102. The height of the protrusion 704, as measured from the top surface of UV ink coating layer 102, can range from about 0.5 mm to about 13 mm and/or 1 inch to 1 foot. The area of the protrusion surface may be in the range of, for example, about 144 mm² to about 7000 mm² and/or 1 square inch to 100 square yards. In some implementations, the length of the protrusion 704 extends from the toe of the shoe to the heel of the shoe. In other embodiments, the protrusion extends from one end of the Decorative Product to an opposite end thereof.

In some implementations, the design to be formed on the protrusion may be fabricated on a transfer sheet (e.g., printed on an adhesive transfer sheet or heat transfer sheet) having about the same area as the planar surface of the protrusion. Using, e.g., a heat press, the design may be affixed to the protrusion. FIG. 7B is a schematic illustrating another example of a shoe containing an UV ink coating layer 102 having jewel-shaped elements and a protrusion 704 on which a user has affixed a design in the form of a name (i.e., “Stacy”). Other portions of the shoe contain other fabrics, such as leather or fake fur.

Another embodiment of the present disclosure may utilize a hologram technique to produce the jewel-shaped elements among other things. One non-exclusive example of a hologram technique considered herein is explained in “Inkjet printing of transparent sol-gel computer generated holograms” written by Aleksandr V. Yakovlev, Evgeny A. Pidko, and Alexandr V. Vinogradov, the contents of which are hereby incorporated herein in entirety. As is understood in the art, hologram techniques utilize an interference pattern of laser beams to generate three-dimensional versions of an object. In the present disclosure, the hologram technique may be implemented to allow the jewel shaped elements to take on a 3-dimensional appearance while having a substantially planer surface.

In one aspect of this disclosure, a more advanced hologram method may be used that involves an inkjet printer as is known in the art. The advanced hologram technique may serve as one non-exclusive step for making the jewel shaped elements discussed herein. As such, the jewel-shaped raised elements produced by hologram method may be less time-consuming and hologram materials may be less expensive than other techniques and materials such as injection molding or compression molding techniques with the use of plastic or lucite materials. A number of implementations of the disclosure have been described. Nevertheless, it will be understood that various modifications may be made without departing from the spirit and scope of the disclosure. Other implementations are within the scope of the following claims.

1. An outer surface of a Decorative Product comprising:
a UV ink coating layer disposed on at least a portion of the outer surface of and facing towards an exterior of the Decorative Product, wherein the UV ink coating layer includes a plurality of close-packed jewel-shaped elements, and the surface of the UV ink coating layer comprises an elongated mesa-like protrusion having a planar top face; and
an outer protective layer disposed on the surface of the UV ink coating layer, wherein the outer protective layer includes an amber varnish layer.

2. The Decorative Product of claim 1, wherein the jewel-shaped elements are raised or planar jewel-shaped elements.

3. The Decorative Product of claim 1, wherein each of the jewel-shaped elements comprises a plurality of facets, each facet is raised at an oblique angle from at least one other facet in the jewel-shaped element.

4. The Decorative Product of claim 1, wherein each jewel-shaped element has a short axis and a plurality of boundaries extending along directions normal to the short axis, the plurality of boundaries enclosing one or more facets on a face of the each jewel-shaped element.

5. The Decorative Product of claim 4, wherein the boundaries of the each jewel-shaped element are grooves.

6. The Decorative Product of any one of claim 1, wherein a clear, self-adhesive vinyl is applied across the jewel-shaped elements.

7. The Decorative Product of claim 1, wherein the jewel-shaped elements are of at least one color.

8. The Decorative Product of claim 1, wherein the outer surface is formed from one or more of natural leather, artificial leather, composite leather, cotton, polyester, rubber, fake or natural fur, artificial or natural animal skins, metal, plastic, wood, fiberglass, or composites.

9. The Decorative Product of claim 1, further comprising one or more light emitting devices, a switch and a power source, wherein the one or more light emitting devices are coupled to the switch and the power source through one or more wires and are embedded in one or more housings, and wherein a portion of the outer surface forms sidewalls to the housings, and the outer covering layer forms a cover of the one or more housings.

10. The Decorative Product of claim 1, wherein the outer covering layer further comprises a polyurethane layer over the amber varnish layer.

11. The Decorative Product of any one of claim 1, wherein the UV ink coating layer covers the entire surface of the outer surface of the Decorative Products.

12. The Decorative Product of claim 1 further wherein the Decorative Product is one of footwear, skates, a skate board, a hoover board, water skis, a snowboard, skis, a writing instrument, an automobile, a boat, a cruiser, an off-road vehicle, a motorcycle, a bicycle, a scooter, a golf club, eyeglasses, an article of furniture, clothing, a caps, a hat, a visors, a computer case, a computer mouse, a keyboard, a monitor, a home appliance, or a kids toys.

13. A decorative product comprising:
a sole;
an upper attached to the sole, wherein the upper comprises an interior lining;
a decorative outer layer fixed to the interior lining, the decorative outer layer being composed of a contiguous transparent or translucent plastic material having close packed jewel-shaped elements defined therein; and
wherein each jewel-shaped element has a short axis and a plurality of boundaries extending along directions normal to the short axis, the plurality of boundaries enclosing one or more facets on a face of the jewel-shaped element; and
wherein the jewel-shaped elements of the decorative outer layer are formed therein utilizing a hologram technique and the jewel-shaped elements comprise an elongated mesa-like protrusions having a substantially planar top face.

14. The Decorative Product of claim 13, wherein the jewel-shaped elements are raised or planar jewel-shaped elements.

15. The Decorative Product of claim 13, wherein each of the jewel-shaped elements comprises a plurality of facets, each facet is raised at an oblique angle from at least one other facet in the jewel-shaped element.

16. The Decorative Product of claim 13, wherein each jewel-shaped element has a short axis and a plurality of boundaries extending along directions normal to the short axis, the plurality of boundaries enclosing one or more facets on a face of the each jewel-shaped element.

17. The Decorative Product of claim 16, wherein the boundaries of the each jewel-shaped element are grooves.

18. The Decorative Product of any one of claim 13, wherein a clear, self-adhesive vinyl is applied across the jewel-shaped elements.

19. The Decorative Product of claim 13, wherein the jewel-shaped elements are of at least one color.

20. The Decorative Product of claim 13, wherein the outer surface is formed from one or more of natural leather, artificial leather, composite leather, cotton, polyester, rubber, fake or natural fur, artificial or natural animal skins, metal, plastic, wood, fiberglass, or composites.

21. The Decorative Product of claim 13, further comprising one or more light emitting devices, a switch and a power source, wherein the one or more light emitting devices are coupled to the switch and the power source through one or more wires and are embedded in one or more housings, and wherein a portion of the outer surface forms sidewalls to the housings, and the outer covering layer forms a cover of the one or more housings.

22. The Decorative Product of claim 13, wherein the outer covering layer further comprises a polyurethane layer over the amber varnish layer.

23. The Decorative Product of any one of claim 13, wherein the UV ink coating layer covers the entire surface of the outer surface of the Decorative Products.

24. The Decorative Product of claim 13 further wherein the Decorative Product is one of footwear, skates, a skate board, a hoover board, water skis, a snowboard, skis, a writing instrument, an automobile, a boat, a cruiser, an off-road vehicle, a motorcycle, a bicycle, a scooter, a golf club, eyeglasses, an article of furniture, clothing, a caps, a hat, a visors, a computer case, a computer mouse, a keyboard, a monitor, a home appliance, or a kids toys.
